(19) United States
(12) Patent Application Publication
(10) Pub. No.: US 2005/0207008 A1
(43) Pub. Date: Sep. 22, 2005

(54) Structure and generated method of a polarizer

(76) Inventors: Jung-Hung Hsu, Tao-Yuan (TW); Long-Hai Wu, Tao-Yuan (TW)

Correspondence Address: BIRCH STEWART KOLASCH & BIRCH, PO BOX 747, FALLS CHURCH, VA, 22040-0747, US

(21) Appl. No.: 10/942,868

(22) Filed: Sep. 17, 2004

(30) Foreign Application Priority Data
Mar. 19, 2004 (TW) 093107540

(51) Int. Cl. G02B 1/00; G02B 5/30; G02B 27/28

(52) U.S. Cl. 359/491; 359/432

(57) ABSTRACT

A structure and generated method of a polarizer is provided in this present invention that comprises a black dye layer formed form a black dye. The black dye layer is located on a protective layer that absorbs an emissive light from a polymer film. Furthermore, a thickness of the black dye layer depends on the desirable saturation of absorbency. The view angle of a displayed apparatus could be improved by the structure of the polarizer in this present invention.

### BACKGROUND OF THE INVENTION

1. Field of the Invention

The present invention relates to a structure and generated method of a polarizer, and more particularly to a structure and a generated method with a polarizer to improve the view angle of a display.

2. Description of the Prior Art

Polarizer is also known as polarizing film, which polarizes the light from a non-polarized light to a polarized light, therefore; a polarized light is formed. Producing the polarized light is utilized the ways as following: (a) utilizing the specific materials with the characteristic of dichroism such as Iodine compounds or dye; (b) utilizing the species having the character of birefringence such as Nicol spar or Glan-Thiomson crystal etc.; (c) utilizing the reflectivity and refractivity between the interfaces of the two species that stacked a few transparent films (such as glass) having different thickness, so the light beam will be filtered layer by layer when it is incident toward to the transparent films with a suitable angle. Thus, the output light beam has the definite extinction ratio, and a partially polarized light is obtained.

Typically, the polarizing film is divided into absorbed type and reflective type, and absorbed type is further divided into O type, E type, dye type and Iodine type polarizing film. The dye type and Iodine type utilize the Iodine ion (I₃⁻ and I₅⁻) permeated into a polymer film such as polyvinyl alcohol (PVA). By Iodine ion or dye molecules have regular ordination thereof, the polymer film can absorb the light vector, which is parallel to the direction of Iodine so that the light vector, which is perpendicular, is passed through. Hence, a polarizing film with the character for polarizing the light is produced. Normally, TFT-LCD has the dye type or Iodine type polarizing film. It notes that a protective film such as triacetyl-cellulose (TAC) is formed respectively on two sides of the PVA film, which is extended to several millimeters. Consequently, the PVA film and TAC films constitute a structure of polarizing film having a sandwich like structure.

The phenomenon of polarization is common to apply in the liquid crystal display (LCD) such as laptop, desktop, PDA, cell phone, etc. The polarizing film acts as a filter to the light. When the voltage is not applied, the liquid crystal molecules are arranged to 90° that associates with the order of the coordination film placed on the upward polarizing film and downward polarizing film respectively. The polarized light is formed after the light beam is passed through the downward polarizing film, moreover; because of the optical anisotropy of the liquid crystal molecules, the polarized light is passed through the upward polarizing film along the liquid crystal molecules, which are twisted to 90°. Hence, the LCD will be “light”. However, after the voltage is applied, the liquid crystal molecules having the twist of 90° have become perpendicular in the order, so that the polarized light passes through the downward polarizing film in the original direction, and the upward polarizing film is shielded. Therefore, the LCD is “dark”. According to the principle thereon, the appearance of LCD can be controlled to be light or dark.

The LCD device has become popular nowadays, however; it has some technologies that need to be improved, such as the limitation in view angle, the response time and brightness. The principle of LCD is that utilizes the liquid crystal molecules to twist the direction of polarized light and the character of double refraction to achieve the purpose of light/dark. However, the LCD naturally has a problem with the view angle. The quality of display depends on where the viewer is, and the contrast ratio has become lower when the view angle is getting bigger. Hence, following the maximized development in the LCD apparatus, the technology of wide-viewing angle (WVA) is becoming important.

FIG. 1 shows schematically cross-sectional view of a conventional polarizing film for a LCD apparatus. Firstly, referring to FIG. 1, an upward polarizing film 101 and a downward polarizing film 101′ are provided in a LCD apparatus. The upward polarizing film 101 comprises a polymer film 103 and a plurality of protective films 105, and the downward polarizing film 101′ comprises a polymer film 103′ and a plurality of protective films 105′. The protective film 105/105′ are formed on the upside and downside of the polymer film 103/103′ respectively. The polymer film can be a PVA film, moreover; a plurality of dichroism materials (not shown in the figure) is added in the polymer film 103/103′ such as Iodine ion (I₃⁻ and I₅⁻) or dye. Due to the fact that Iodine ion or dye is in a regular order on the polymer film 103/103′, the light vector paralleled to the dichroism materials' direction is absorbed, but the one perpendicular to the dichroism materials is passed through. It means that a structure with the upward polarizing film 101 and downward polarizing film 101′ has a function for making the light beam from non-polarization to polarization.

In addition, the protective films 105/105′, such as TAC film, cellulose aceto butyrate (CAB) layer and acrylic resin layer, are formed on two sides of the polymer film 103/103′ respectively within the upward polarizing film 101 and downward polarizing film 101′. The protective films 105/105′ in the upward polarizing film 101 and downward polarizing film 101′ are utilized to protect the polymer film 103/103′ from damage of moisture, heat and mechanism. Besides, the protective films need the character of high transparency to prevent the interference from the polarized light.

Next, a structure with the upward polarizing film 101 and downward polarizing film 101′ is applied within a LCD apparatus. The LCD apparatus comprises a LC cell 107, an upward polarizing film 101 and a downward polarizing film 101′, wherein the LC cell 107 comprises a plurality of liquid crystal molecules such as a twisted nematic (TN) liquid crystal molecules. In addition, the upward polarizing film 101 is placed to 90° with the downward polarizing film 101′, and the liquid crystal molecules within the LC cell 107 are also twisted and being parallel in order thereof. Because of the optical anisotropy, the light beam without polarization will be polarized to the polarized light after passing through the downward polarizing film 101′. Moreover, the polarized light will go along with the liquid crystal molecules within the LC cell 107, and arrive to the upward polarizing film 101. However, when a voltage is applied to the LCD apparatus, the liquid crystal molecules within the LC cell 107 will become perpendicular in ordination, and being identical with the direction of the polarized light passed through the downward polarized film 101′. Due to the fact that the upward polarizing film 101 and downward polarizing film are placed to 90°, the polarized light can not pass though the upward polarizing film 101 from the downward polarizing film 101′. According to the theory mentioned above, controlling the direction of the rotation in the liquid crystal molecules through the voltage can alter the statement of light/dark on the LCD apparatus.

To make the liquid crystal molecules are placed in order on the upward polarizing film 101 and downward polarizing film 101′, the upward polarizing film 101 and downward polarizing film 101′ have to perform the rubbing process. By the rubbing process, the control of the liquid crystal molecules are disposed in a unique direction within a unique area, wherein the treatment of orientation on the surface of the upward polarizing film 101 and downward polarizing film 101′ is performed to form a coordination film (not shown in the figure). The coordination film exists a van der waals interaction, dipole-dipole interaction and hydrogen bond etc. to make the liquid crystal molecules be successivein order.

After applying the voltage to the LCD apparatus, the liquid crystal molecules nearby and the upward polarizing film 101 and downward polarizing film 101′ can not be perpendicular in order because of the effect from the rubbing on the polarizing film. It means that will produce a pretilt angle so that a number of polarized lights can pass through the liquid crystal molecules and arrive to the upward polarizing film 101. Hence, the viewer will observe the illuminated points when the statement is “dark” that is to say, it is a statement of light leakage in the dark. As a result, the contrast ratio of a display is definite as light brightness divided by dark brightness, the phenomenon of light leakage in the dark will directly influence the dark brightness of LCD apparatus, and further influence the contrast ration of an LCD apparatus. Therefore, the phenomenon of light leakage in the dark will influence the view angle of the LCD apparatus, that is one of the reasons for an improper view angle of the LCD apparatus.

In addition, the polymer films 103/103′ comprise a plurality of dichroism materials; nevertheless, the dichroism materials such as Iodine ion emit a light with a specific wavelength under the dark statement after applying the voltage. By a real observation, the wavelength is about 400 μm that causes the phenomenon of light leakage in the dark, which influences the dark brightness and contrast ratio of the LCD apparatus, and further to influence the view angle of the LCD apparatus. That is to say, it is one of the reasons for an improper view angle in the display apparatus.

### SUMMARY OF THE INVENTION

As the above-mentioned description, the liquid crystal molecules will generate the pre-tilt angle and the Iodine ion will emit the light having a specific wavelength, both of which influence the dark brightness of the LCD after applying the voltage to a display apparatus. The problem thereon prevents the display apparatus from obtaining the proper view angle. To solve the problem thereof, the present invention provides a polarizer to improve the problem with an insufficient view angle in the display apparatus.

It is an objective of the present invention to provide a structure and generated a method of a polarizer, wherein a black dye layer is added in the polarizer to effectively reduce the dark brightness of a display apparatus and enhance the contrast ration of a display apparatus.

It is another objective of the present invention to provide a structure and a generated method of a polarizer, wherein a black dye layer is mixed with an optical film in the polarizer to absorb the light emitted from the dichroism materials in the polymer film and enhance the view angle of a display apparatus.

It is further objective of the present invention to provide a black dye, and utilizing the simple and convenient process to achieve the purpose with improving the view angle of a display apparatus.

In order to achieve the objects as mentioned above, the present invention provides a polarizer for improving the view angle, which comprises a polymer film, a plurality of protective films and at least a black dye layer. The plurality of protective layers is placed on the upside and downside of the polymer film respectively, which comprises a plurality of dichroism materials such as Iodine ion. Also, the black dye layer is placed on the surface of one of the protective films that absorbs the light emitted from the plurality of dichrosim materials. The black dye layer comprises a black dye and a thermal resin, and the thickness of the black layer depends on the desirable saturation of absorbency. By the polarizer of the present invention, the dark brightness of the display apparatus is effectively reduced, and the contrast ration is improved. Hence, the view angle of the display apparatus is enhanced.

The above-mentioned polarizer can also utilize the black dye layer mixes with an optical film layer such as an anti-glare layer or an anti-reflection layer to form a mixed layer on the protective layers.

### BRIEF DESCRIPTION OF THE DRAWINGS

The objectives and features of the present inventions as well as advantages thereof will become apparent from the following detailed description, considered in conjunction with the accompanying drawings. It is to be understood, however, that the drawings, which are not to scale, are designed for the purpose of illustration and not as a definition of the limits of the invention, for which reference should be made to the appended claims.

The present invention can be best understood through the following description and accompanying drawings, wherein:

FIG. 1 shows schematically cross-sectional views of a conventional polarizer in a LCD apparatus;

FIG. 2 shows schematically cross-sectional views of one preferred embodiment according to the present invention that a structure and generated method of a polarizer for improving the view angle;

FIG. 3 shows schematically cross-sectional views of another preferred embodiment according to the present invention that a structure and generated method of a polarizer for improving the view angle; and

FIG. 4 shows schematically cross-sectional views of still another preferred embodiment according to the present invention that a polarizer applied in a display apparatus for improving the view angle.

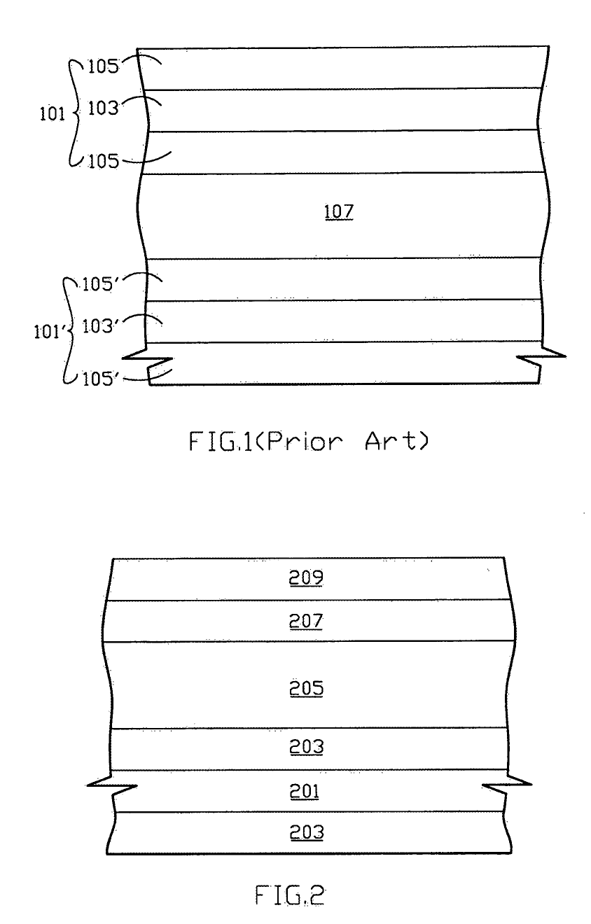

### DESCRIPTION OF THE PREFERRED EMBODIMENT

The present invention provides a structure and generated method of a polarizer that firstly forms a polymer film comprising a plurality of dichroism materials such as Iodine ion therein. Next, the protective films are formed on the upside and downside of the polymer film respectively. Then, at least one layer of the black dye layer is formed on the surface of one of the protective films, wherein the black dye layer comprises a black dye and a thermal resin therein. After that, at least an optical layer is formed on the surface of the black dye layer. Moreover, the polarizer of the present invention can be applied into a display apparatus.

Preferred embodiments of this invention will be explained with reference to the drawings of FIG. 2. Referring to FIG. 2A, a polymer film 201 having the thickness about several 10 micrometers is firstly provided such as a polyvinyl alcohol (PVA) film. The polymer film 201 comprises a plurality of dichroism materials such as Iodine ion or dye molecules, which utilize a way of infiltration to add in the polymer film 201. After slightly heating, the polymer film 201 is stretched to a uniaxial direction to make the Iodine ion of the plurality of dichroism materials from irregular distribution toward to a specific direction. Thus, the ordination of Iodine ion or dye molecules will have a particular direction. A light vector parallel to the ordination of the dichroism materials is absorbed, but the light vector perpendicular to the ordination of the dichroism materials is passed through.

As a result, the mechanical property of the polymer film 201 will be reduced and become easily breakable after stretching the polymer film 201. Hence, the protective films 203, such as TAC film, are formed on the upside and downside of the polymer 201 to support and protect the polymer film 201 and prevent the polymer film from shrinking. Because of the high moisture permeability, the protective films 203 are utilized to protect the polymer film 201, therefore; the polymer film 201 can prevent the damage of moisture and high temperature. Also, the protective films 203 need to have the properties with durability and high transparency to avoid interfering with polarization. Subsequently, the protective films 203 are adhered with the polymer film 201 through an adhesive layer, which is sensitive to pressure. The adhesive layer can be polyacrylate.

Next, at least one black dye layer 205 is formed on one of the protective films 203 to absorb the light emitted from the dichrosim materials within polymer film 201 that reduces the dark brightness. Hence, the contrast ratio of the display apparatus is enhanced, and the view angle is further improved. The black dye layer 205 has an adhesion that utilizes a black dye mixed with a resin through a solvent, wherein the resin is a thermal resin and the solvent is ethanol. After the solvent evaporates, the black dye layer 205 is completely adhered with the protective films 203. In addition, the black dye layer 205 has the property of saturation for absorbing the light so that the thickness of the black dye layer 205 can be utilized to decide the desirable saturation. Furthermore, the black dye layer 205 needs to have the proper transparency for light.

Then, a first optical layer 207 is formed on the black dye layer 205 such as an anti-reflection layer that can reduce the interference with the light from outside, and further improve the light transparency and contrast ratio. Moreover, the first optical film 203 also needs to have the proper characteristics with transparency, hardness, adhesion, thermal endurance and durability. After forming the first optical layer 207, a second optical layer 209 is formed on the surface of the first optical layer 207, such as an anti-glare layer, to reduce the reflection from outside. The second optical layer 209 is utilizes an appropriate method, such as sandblasting, embossing or blending a plurality of transparent particles to form an aspirate surface to achieve the effect of anti-glaring. Finally, the polarizer of present invention is accomplished.

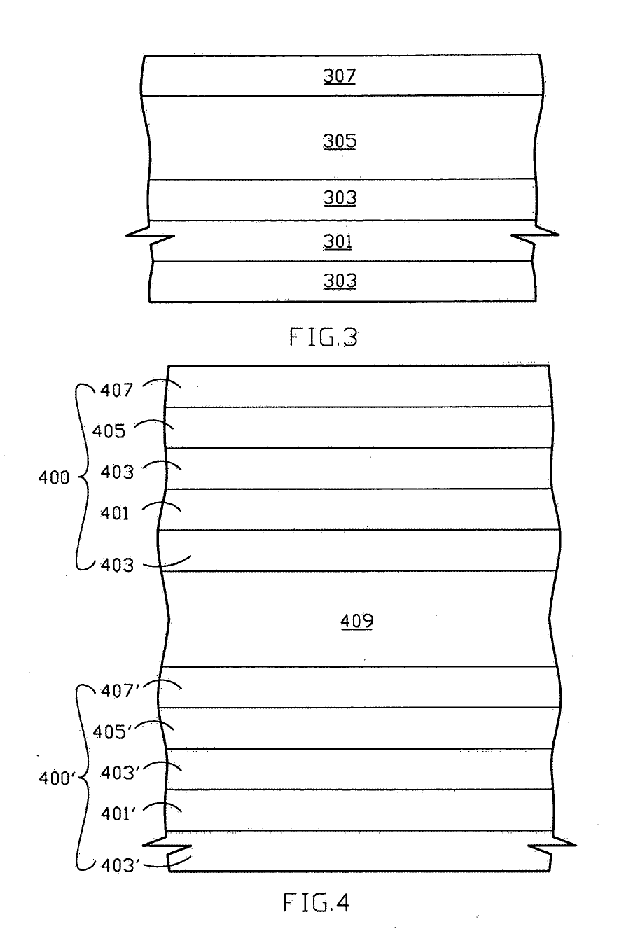

Another preferred embodiment of this invention will be explained with reference to the drawings of FIG. 3 that the polymer film 301 and protective films 303 have the same structure and character with the polymer film 201 and protective films 203 in FIG. 2. Nevertheless, in FIG. 3, at least a mixed layer 305 is formed on one of the protective films 303, which is formed on the polymer film 301, to absorb the wavelength emitted from the dichroism materials in the polymer film 301. The formation of the mixed layer 305 utilizes a solvent mixed with a black dye layer, a first optical layer and a resin provides adhesion, wherein the resin can be a thermal resin and the solvent is ethanol. Thus, the mixed layer 305 can adhere on one of the protective films 303, and after the solvent evaporates, the mixed layer 305 is completely adhered with the protective film 303. In addition, the black dye layer has the property of saturation for absorbing the light so that the thickness of the mixed layer 305 can be utilized to decide the desirable saturation. Furthermore, the mixed layer 305 needs to have the proper transparency for light.

It notes that the black dye layer is mixed with an anti-reflection layer to form the mixed layer 305, an anti-glare layer is formed on the surface of the mixed layer 305. On the contrary, if the black dye layer is mixed with an anti-glare layer to form the mixed layer 305, an anti-reflection layer is formed on the surface of the mixed layer 305.

Subsequently, a second optical layer 307, such as an anti-reflection layer anti-glare layer, is formed on the surface of the mixed layer 305. It notes that the mixed layer 305 and the second optical layer 307 can reduce the interference with the light from outside, and further improve the light transparency and contrast ratio. Moreover, the second optical film 307 also needs to have the proper characteristics with transparency, hardness, adhesion, thermal endurance and durability. Besides, if the second optical film 307 is an anti-glare layer, utilizing an appropriate method, such as sandblasting, embossing or blending a plurality of transparent particles to form a surface of asperity on the second optical layer 307 to achieve the effect of anti-glaring. Finally, the polarizer of the present invention is accomplished.

Still another preferred embodiment of this invention will be explained with reference to the drawings of FIG. 4 that the polarizer of the present invention in a display apparatus is applied. Referring to FIG. 4, a polarizer is provided firstly, wherein the polarizer comprises an upward polarizer 400 and a downward polarizer 400′. The upward polarizer 400 comprises a polymer film 401 and a plurality of protective film 403, which are formed on the upsides and downsides of the polymer film 401. The downward polarizer 400′ comprises a polymer film 401′ and a plurality of protective films 403′, which are formed on the upsides and downsides of the polymer film 401′. The polymer films 401/401′ can be a PVA film, moreover; a plurality of dichroism materials, such as Iodine ion (I₃⁻ and I₅⁻) or dye molecules, is within the polymer film 401/401′. Due to the fact that the plurality of dichroism materials have a regular arrangement in the polymer films 401/401′, the non-polarized light is provided from the downward polarizer 400′ that will pass through the downward polarizer 400′ and a display apparatus 409 and then achieve to the upward polarizer 400. The plurality of dischroism materials in the downward polarizer 400′ will absorb the light vector, which is parallel to the dischroism materials, however; the light perpendicular to the dischroism materials is passed through. Hence, the light non-polarized is become polarized.

Due to the fact that the plurality of dichroism materials within the polymer film 401/401′ such as Iodine ion is still emitting the specific wavelength under the dark statement after applying the voltage, therefore; the statement of light leakage in the dark is generated within the LCD apparatus. However, the contrast ratio of the LCD apparatus is definite as light brightness divided by dark brightness so that the problem of light leakage in the dark will influence the dark brightness and the value of the ratio, and further influence the view angle of the LCD apparatus. In order to solve the problem as above mentioned, the present invention provides at least a mixed layer 405/405′ formed on one of the protective films 403/403′. The mixed layer 405/405′ comprises a black dye layer and a first optical layer and a resin (not shown in the figure) that absorbs the light emitted from the dichroism materials within the polymer films 401/401′. Therefore, the dark brightness of the LCD apparatus is reduced to improve the contrast ratio, and further enhance the view angle of the LCD apparatus. The resin is a thermal resin and the first optical film is an anti-reflection layer or anti-glare layer. In addition, the black dye layer within the mixed layer 405/405′ has the property of saturation for absorbing the light so that the thickness of the mixed layer 405/405′ can be utilized to decide the desirable saturation.

Next, a second optical layer 407/407′, such as an anti-reflection layer anti-glare layer, is formed on the surface of the mixed layer 405/405′. It notes that the mixed layer 405/405′ and the second optical layer 407/407′ can reduce the interference with the light from outside, and further improve the light transparency and contrast ratio. Moreover, the second optical film 407/407′ also needs to have the proper characteristics with transparency, hardness, adhesion, thermal endurance and durability. Besides, if the second optical film 407/407′ is an anti-glare layer, utilizing an appropriate method, such as sandblasting, embossing or blending a plurality of transparent particles to form an surface of asperity on the second optical layer 307 to achieve the effect of anti-glaring.

It notes that the black dye layer and the first optical layer in the mixed layer 405/405′ can be independent, that is; the black dye layer can form on one of the protective films 403/403′ formed on the polymer film 403/403′. The first optical layer is formed on the black dye layer, and then the second optical layer is subsequently formed thereon.

According to the description of preferred embodiments of the present invention, as mentioned above, it will be realized that present invention provides a polarizer comprising a black dye to absorb the wavelength emitted from the dichroism materials in the polymer film. Hence, the value of dark brightness can be reduced, and the contrast ratio can be enhanced. Therefore, the view angle of the display apparatus is improved.

The preferred embodiments are only used to illustrate the present invention, not intended to limit the scope thereof. Many modifications of the preferred embodiments can be made without departing from the spirit of the present invention.

1. A method of forming a polarizer for improving a view angle, comprising:
providing a polymer film comprising a plurality of dichroism materials therein;
providing a protective film placed on an upside and a downside of said polymer film respectively; and
providing at least a black dye layer on said protective film to absorb a light emitted from said plurality of dichroism materials.

2. The method of claim 1, wherein said black dye layer comprises a resin and a black dye.

3. The method of claim 2, wherein said resin is a thermal resin.

4. The method of claim 3, wherein the thickness of said black dye layer depends on the desirable saturation.

5. The method of claim 1, further comprising a first optical layer formed on said black dye layer.

6. The method of claim 5, further comprising a second optical layer formed on said black dye layer.

7. A structure of a polarizer for improving a view angle, comprising:
a polymer film comprising a plurality of dichroism materials;
a protective film placed on an upside and a downside of said polymer film respectively; and
a black dye layer is on one side of said protective film to absorb the light emitted from said plurality of dichroism materials.

8. The structure of a polarizer for improving a view angle according to claim 7, wherein said black dye layer comprises a black dye and resin.

9. The structure of a polarizer for improving a view angle according to claim 8, wherein said resin is a thermal resin.

10. The structure of a polarizer for improving a view angle according to claim 7, wherein the thickness of said black dye layer depends on the desirable saturation of absorbency.

11. The structure of a polarizer for improving a view angle according to claim 7, further comprising a first optical layer formed on said black dye layer.

12. The structure of a polarizer for improving a view angle according to claim 11, further comprising a second optical layer formed on said black dye layer.

13. A method of forming a polarizer for improving a view angle, comprising:
providing a polymer film comprising a plurality of dichroism materials therein;
providing a protective film placed on an upside and a downside of said polymer film respectively; and
providing at least a mixed layer on said protective film to absorb the light emitted from said plurality of dichroism materials.

14. The method of claim 13, wherein said mixed layer comprises a black dye layer and a first optical layer.

15. The method of claim 13, wherein the thickness of said black dye layer depends on the desirable saturation.

16. The method of claim 14, wherein said black dye layer comprises a resin and a black dye.

17. The method of claim 16, wherein said resin is a thermal resin.

18. The method of claim 14, wherein said first optical film is an anti-reflection layer.

19. The method of claim 14, wherein said first optical film is an anti-glare layer.

20. The method of claim 13, further comprising a second optical layer formed on said mixed layer.

21. The method of claim 20, wherein said second optical layer is an anti-reflection layer.

22. The method of claim 20, wherein said second optical layer is an anti-glare layer.

23. A structure of a polarizer for improving a view angle, comprising:
a polymer film comprising a plurality of dichroism materials;
a protective film placed on an upside and a downside of said polymer film respectively; and
a mixed layer is on one side of said protective film.

24. The structure of a polarizer for improving a view angle according to claim 23, further comprising a black dye layer mixed with a first optical layer to form said mixed layer.

25. The structure of a polarizer for improving a view angle according to claim 23, wherein the thickness of said mixed layer depends on the desirable saturation of absorbency.

26. The structure of a polarizer for improving a view angle according to claim 23, further comprising a second optical layer on said mixed layer.

27. The structure of a polarizer for improving a view angle according to claim 24, wherein said black dye layer comprises a resin and a black dye.

28. The structure of a polarizer for improving a view angle according to claim 24, wherein said resin is a thermal resin.

29. The structure of a polarizer for improving a view angle according to claim 24, wherein said first optical layer is an anti-reflection layer.

30. The structure of a polarizer for improving a view angle according to claim 24, wherein said first optical layer is an anti-glare layer.

31. The structure of a polarizer for improving a view angle according to claim 26, wherein said second optical layer is an anti-reflection layer.

32. The structure of a polarizer for improving a view angle according to claim 26, wherein said second optical layer is an anti-glare layer.

33. A method of improving a view angle of a display apparatus, comprising:
providing a polymer film comprising a plurality of dichroism materials therein;
providing a protective film placed on an upside and a downside of said polymer film respectively;
providing at least a mixed layer on said protective film to form a polarizer to absorb the light emitted from said plurality of dichroism materials; and
placing said polarizer in said display apparatus to improve the view angle of said display apparatus.

34. The method of claim 33, wherein said mixed layer comprises a black dye layer and a first optical layer.

35. The method of claim 34, wherein said black dye layer comprises a resin and a black dye.

36. The method of claim 35, wherein said resin is a thermal resin.

37. The method of claim 33, wherein the thickness of said mixed layer depends on the desirable saturation of absorbency.

38. The method of claim 34, wherein said first optical layer is an anti-reflection layer.

39. The method of claim 34, wherein said first optical layer is an anti-glare layer.

40. The method of claim 33, further comprising a second optical layer formed on said mixed layer.

41. The method of claim 40, wherein said second optical layer is an anti-reflection layer.

42. The method of claim 34, wherein said second optical layer is an anti-glare layer.

43. A structure of a polarizer for improving a view angle of a display apparatus, comprising:
a first polarizer comprising a mixed layer therein;
a display apparatus placed on said first polarizer; and
a second polarizer placed on said display apparatus.

44. The structure of a polarizer for improving a view angle according to claim 43, wherein said mixed layer comprises a black dye layer and a first optical layer.

45. The structure of a polarizer for improving a view angle according to claim 44, wherein said black dye layer comprises a black dye and a resin.

46. The structure of a polarizer for improving a view angle according to claim 45, wherein said resin is a thermal resin.

47. The structure of a polarizer for improving a view angle according to claim 43, wherein the thickness of said mixed layer depends on the desirable saturation of absorbency.

48. The structure of a polarizer for improving a view angle according to claim 44, wherein said first optical layer is an anti-reflection layer.

49. The structure of a polarizer for improving a view angle according to claim 44, wherein said first optical layer is an anti-glare layer.

50. The structure of a polarizer for improving a view angle according to claim 43, further comprising a second optical layer is formed on said mixed layer.

51. The structure of a polarizer for improving a view angle according to claim 50, wherein said second optical layer is an anti-reflection layer.

52. The structure of a polarizer for improving a view angle according to claim 50, wherein said second optical layer is an anti-glare layer.
